(19) United States
(12) Patent Application Publication
(10) Pub. No.: US 2006/0213170 A1
(43) Pub. Date: Sep. 28, 2006

(54) Blade for a crop harvesting header with rotary disks

(76) Inventor: Neil Gordon Barnett, Winnipeg (CA)

Correspondence Address: ADE & COMPANY INC., P.O. BOX 28006 1795 HENDERSON HIGHWAY, WINNIPEG, MB, R2G1P0, CA

(21) Appl. No.: 11/087,774

(22) Filed: Mar. 24, 2005

(51) Int. Cl. A01D 34/52

(52) U.S. Cl. 56/295

(57) ABSTRACT

A crop harvesting header has a cutter bar with a plurality of generally horizontal flail disks mounted thereon for driven rotation about generally upright axes spaced along the cutter bar. The disks each carry a pair of blades at diametrically opposed positions. The blades are shaped such that a leading cutting edge lies generally in a radial plane of the axis and extends generally outwardly from the axis from an inner end of the leading edge to an outer end of the leading edge where the outer end of the leading edge is angularly advanced relative to the inner end. This can be achieved by moving the pivot point of the blade pivot axis forward toward the leading edge. The blade may be twisted so that the trailing edge is above the leading edge.

This invention relates to a crop harvesting header which has a cutter bar across the width of the header which carries and drives a plurality of transversely spaced rotary disks and particularly to an improved blade therefor.

### BACKGROUND OF THE INVENTION

Crop harvesting headers which use rotary cutters in replacement for the more conventional sickle knife systems have been available for many years. It is well known that such rotary cutters include a cutter bar or gear train which provides the main structural and drive communication components of the cutter. The cutter bar provides a series of longitudinally spaced vertical drive members each of which drives a respective one of a plurality of cutting disks at spaced positions along the cutter bar. The disks are mounted for rotation about a vertical axis standing upwardly from the cutter bar. The disks carry at a point on their outer edge a plurality, generally two, of flail type blades which rotate with the disk around the vertical axis in a cutting action.

The construction of the cutter bar itself including the suitable gear train is well known and a number of different designs are available which can be used by a person skilled in this art.

The structure can be attached to a tractor in the manner of a self propelled system in which the tractor is arranged so that it carries the structure across the front of the tractor so that, when used for this particular equipment, the tractor is dedicated to the machine concerned and carries the structure across the field. Alternatively the support structure can be arranged as a pull type system in which it carries its own wheels for rolling over the ground with the support structure towed behind a conventional tractor using a coupling system. Again the details of such connections either for the self propel system or for the pull type system are well known to skilled in the art.

Examples of such rotary type cutters are shown in the following documents.

U.S. Pat. No. 5,463,852 (O'Halloran) assigned to Hay and Forage industries (Hesston) shows a construction of such a rotary cutter system in which there is a series of the cutter disks at spaced positions across the cutter bar with, at each end, two of the cutter disks extend beyond a central area in front of a discharge opening. In this arrangement the two end disks are driven by a mechanical drive system. The two end disks each carry a rotary transfer element in the form of a series of posts arranged at the periphery of a cylinder surrounding a vertical axis standing upwardly from the disk. The transfer elements act to carry the crop material which is cut by the disks inwardly toward the discharge opening.

U.S. Pat. No. 5,722,222 (Walters) assigned to Deere and Company discloses a pull type rotary cutter of this general type.

U.S. Pat. No. 5,768,865 (Rosenbalm) assigned to Deere and Company discloses a rotary cutter system which has two end disks outboard of the central discharge opening with a conditioner arranged at the discharge opening for receiving the cut crop and providing a conditioning action. The conditioner can be either of a flail type or of a fluted roller type.

The patent discloses a particular construction of converging system which controls the movement of the crop from the outboard disks toward the discharge opening by forming particular arrangements and shaping of panels which act to guide the material relative to the disks.

It will be appreciated that cutters of this general type, and as used in the present invention, can include a conditioner if required but in some cases the conditioner may be omitted. Conditioners of different types can be used as required with the fluted roller arrangement described in detail herein after being only one example of such a conditioner.

Blades for such cutter disks are generally formed simply from a metal plate which has a pivot hole at an inner end and two side edges which form leading and trailing edges one or both of which is sharpened.

Examples of such blades are shown in U.S. Pat. No. 5,842,330 (Richardson) and issued Dec. 1^{st} 1998 and in US Patent Application 2002/0194829 published Dec. 26^{th} 2002 and both assigned to Deere and Company.

### SUMMARY OF THE INVENTION

It is one object of the invention to provide a crop harvesting header of the type having a series of rotary cutting disks on a cutter bar.

According to one aspect of the invention there is provided a crop harvesting header comprising:
a cutter bar mounted across a width of the header for movement across the ground for harvesting a standing crop;
a plurality of generally horizontal cutter disks mounted on the cutter bar at positions spaced transversely of the header with the disks being mounted on the cutter bar for driven rotation about respective generally upright axes spaced along the cutter bar;
each disk having mounted thereon at a position spaced outwardly from the respective axis thereof at least one cutter blade such that rotation of the disk about its axis causes a standing crop to be cut by the blade as it rotates around the axis on the disk;
each of the blades of the cutter disks having a leading cutting edge arranged generally in a radial plane of the axis and extending generally outwardly from the axis from an inner end of the leading edge to an outer end of the leading edge;
each of the blades being shaped and arranged such that the outer end of the leading edge is angularly advanced relative to the inner end.

Preferably the blade is a flail type blade mounted for pivotal movement about a pivot axis inwardly of the inner end of the leading edge and generally parallel to the axis of the respective disk.

Preferably the blade is arranged such that the pivot axis is located such that a line joining the pivot axis and a center of gravity of the blade is at an angle to a line joining the inner end and outer end of the leading edge, such that, with the center of gravity located radially outwardly of the pivot axis due to centrifugal force, the outer end of the leading edge is angularly advanced relative to the inner end.

According to one preferred arrangement the blade is generally rectangular in plan to define the leading edge, a trailing edge, an inner edge and an outer edge and wherein the pivot axis is located at a position closer to the leading edge than the trailing edge.

Preferably in this arrangement the outer edge is inclined rearwardly and inwardly such that the outer end of the leading edge constitutes the radially outermost point on the outer edge.

Preferably the blade is shaped to define an outer edge which is inclined rearwardly and inwardly such that the outer end of the leading edge constitutes the radially outermost point on the outer edge.

Preferably the blade is shaped to define a trailing edge extending generally outwardly from the axis behind the leading edge and the blade is twisted such that the trailing edge is above the leading edge tending to lift the crop as the blade passes through the crop.

In one preferred arrangement, the leading edge lies on a straight line.

Alternatively the leading edge can be curved outwardly and forwardly and is shaped such that each point outward of another point on the leading edge is angularly advanced relative to said another point.

In another preferred arrangement, the blade is shaped to define a line of symmetry extending from the pivot axis along a radial line to an outer edge and a trailing edge extending generally outwardly from the axis behind the leading edge and behind the line of symmetry, and wherein each of the leading edge and the trailing edge are inclined relative to the line of symmetry such that the blade increases in width from the inner end of the leading edge to the outer end of the leading edge.

In this arrangement, preferably both the leading and trailing edges are sharpened to allow the blade to be mounted in reverse orientation.

Preferably each disk has two blades at diametrically opposite positions on the disk.

Preferably the disks are shaped such that the disk has a transverse dimension at the blades which is greater than at a position at ninety degree spacing from the blades.

Preferably the disks are arranged such that the blades of one are ninety degrees offset from the blades of the next.

The term “header” as used commonly and as used in this specification is intended to include both headers carried on self propelled machines, which may therefore not include wheels mounted on the header itself, and headers which are towed behind a tractor and thus may include wheels attached to the header frame or to a component supporting the header.

It is another object of the invention to provide a flail blade for mounting on a rotating member for an improved cutting action on the crop. Thus the blades can be used both on disk type headers of the type described above and also on other rotary cutters where a flail blade is mounted on a rotating member for cutting a standing crop..

According to a second aspect of the invention there is provided a flail blade for mounting on a rotating member for cutting crop, the blade comprising a metal plate having
an opening therein defining a pivot mounting for a pivot axis at which the blade is mounted on the rotating member;
a leading cutting edge arranged generally in a radial plane of the axis and extending generally outwardly from the axis from an inner end of the leading edge to an outer end of the leading edge;
the blade being shaped and arranged such that, when mounted on the pivot mounting and rotated by the rotating member, the outer end of the leading edge is angularly advanced relative to the inner end.

The idea is that by having the cutting edge of a disk mower knife inclined forward to the radial line through the center of the disk and blade pivot, crop material will tend to be gathered by the blade and have less tendency of slipping off the end of the blade into the area which has not yet been cut. Another goal of this design is that more crop will flow over the disks rather than between them and thus the mat of material delivered to the conditioner will be more consistent across its width.

The cutting edge can be straight or curved, but for manufacturing purposes a straight cutting edge is preferable.

In one preferred arrangement the blade has one cutting edge only and the inclination of the cutting edge is obtained by having an asymmetrical blade with the pivot closer to the cutting edge. With this design, the center of the cutting disks, blade pivot and center of mass of the blade will close to lining up when subject to rotational forces. This is the preferred design because it can be manufactured from strip material so that the leading and trailing edges form the parallel edges of the strip material from which the blade is formed. The end of the blade is cropped back so that the outer end of the leading edge is the radially outermost point so it does not interfere with cutting.

In a second version the blade has two cutting edges (fan-shaped) and do not require any asymmetry to function.

### BRIEF DESCRIPTION OF THE DRAWINGS

FIG. 1 is an isometric view showing generally a header of the type with which the present invention is preferably concerned.

FIG. 2 is a top plan view of two of the cutter disks of the header of FIG. 1.

FIG. 3 is a top plan view of one blade of one of the disks of FIG. 2.

FIG. 4 is a front elevational view of the disk of FIG. 3.

FIG. 5 is an end elevational view of the disk of FIG. 3.

FIG. 6 is a top plan view of a second embodiment of blade for use with the disk of FIG. 2.

FIG. 7 is a top plan view of a third embodiment of blade for use with the disk of FIG. 2.

In the drawings like characters of reference indicate corresponding parts in the different figures.

### DETAILED DESCRIPTION

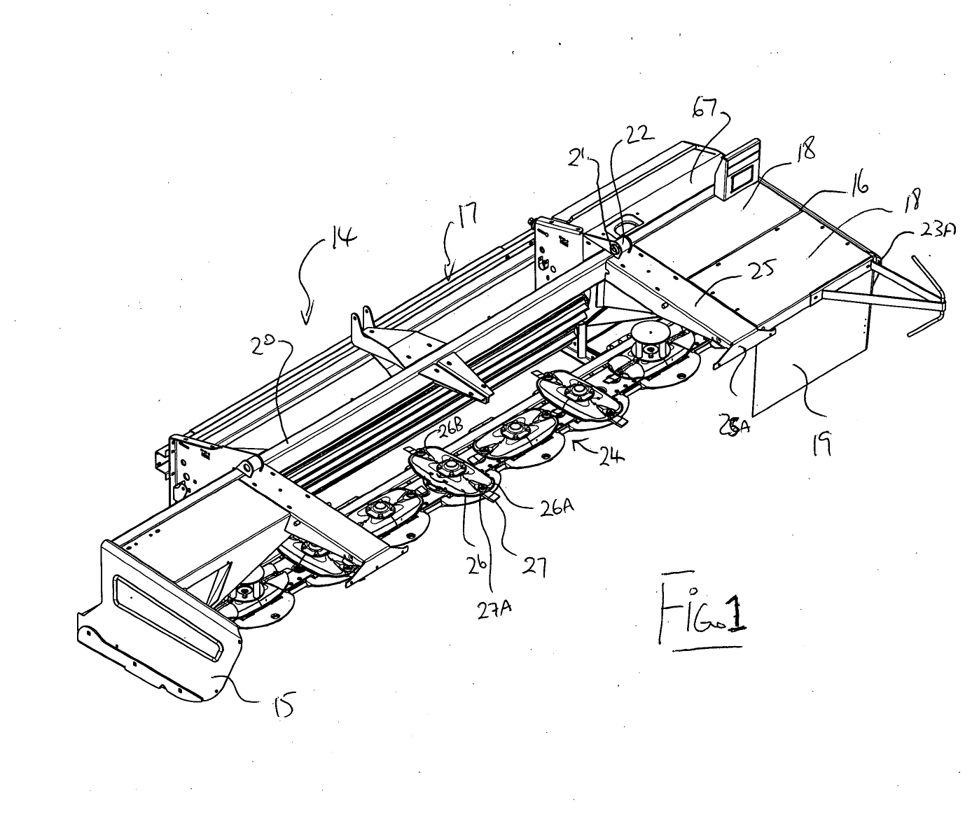

In FIG. 1 is shown schematically a header for attachment to conventional swather tractor of the well known type having driven ground wheels and rear castor wheels. A front support assembly of the tractor carries the header 14 including left and right lift arms which carry the header in a floating action across the ground along skid plates (not shown) of the header. The header includes side walls 15 and 16 forming part of a frame 17 attached to the conventional transport system of the tractor. The frame carries top covers 18 which support a front skirt 19 in front of the cutter bar so as to provide protection for persons in the vicinity of the header which could be impacted by objects accelerated by the high speed rotary cutting assembly described hereinafter.

The frame 17 includes a main transverse beam 20 which is attached to the tractor by a support bushing 21 carried on lugs 22. The main beam 20 carries the side walls 15 and 16 with only the side wall 16 being visible in FIG. 1. The side wall 16 comprises a vertical wall extending forwardly to a front edge 23 in front of the cutter bar which is generally indicated at 24. The side wall is vertical and provides the front edge 23 lying in a vertical plane of the side wall so as to confine crop material to the interior of the header between the side walls for cutting action effected by the cutter bar 24. A crop divider 23A can be provided and is shown in FIG. 1.

An arm 25 extends forwardly from the main beam 20 to provide a front support plate 26 for the curtain 19 which is omitted from the view of FIG. 1. On each side of the arm 25 is provided the cover panels 18 which carry the curtain 19 and again some of these are removed from FIG. 1 for convenience of illustration.

Within the cutter bar is provided a gear train (not shown) of meshing gears carried on suitable bearings so as to provide communication of drive of a number of vertical shafts carried on the cutter bar each for rotating a generally horizontal disk 26 about a vertical axis of the shaft. The disks are substantially identical. The disks are generally elliptical in shape so that a length between two ends 26A and 26B is significantly greater than a distance between the side edges in a direction at right angles to the length. At each of the ends 26A and 26B is mounted a respective one of a pair of flails 27 each for pivotal movement about a flail mounting pin 27A. The mounting pins are arranged at the ends and thus at the maximum extent of the disk so that the flails project outwardly beyond the edges of the disk for rotation in a common horizontal plane generally parallel to the plane of the cutter bar in a cutting action.

The disks are intermeshed so as to driven synchronously and they are arranged at 90° phase difference so that adjacent pairs of the disks are at 90° offset as they rotate to avoid interference between the disks and the blades 27 carried thereby.

In most cases, the cutter bar is wider than a discharge opening with optional conditioning system mounted in the discharge opening. Thus the crop material passes over the disks when cut and also must be converged from the full cut width into the discharge opening.

The cutter bar of this general construction is of a conventional nature and many examples of a commercial arrangement of this type are available in the market place. Thus the details of the cutter bar and its mounting are well known to one skilled in the art and further details can be obtained from such commercial devices, the details of which are incorporated herein by reference.

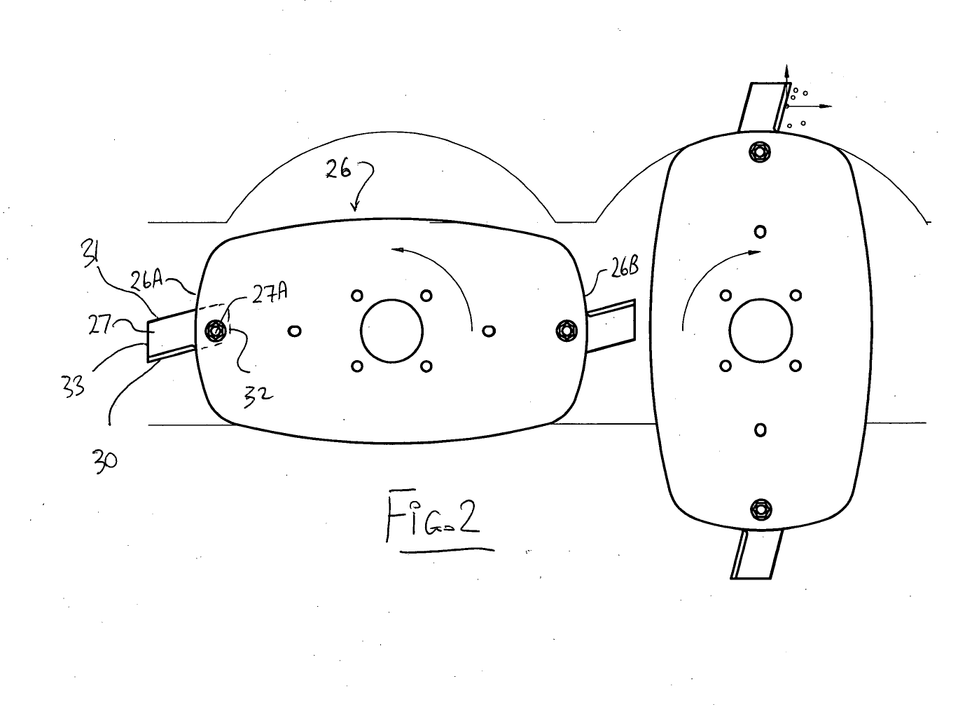

Two of the disks are shown in FIG. 2 in the 90° offset position necessary for cutting so that the outside edge of each flail blade 27 passes closely adjacent to the narrower part of the next adjacent disk. In this way the cutting action of each disk overlaps with the cutting action of the next adjacent disk to ensure that all of the crop is cut across the full width of the header. In FIG. 2 the two disks are shown rotating in opposite directions so that each disk rotates away from the other disk of the pair. However it will be appreciated that different arrangements for the direction of rotation of the disks can be selected so that some pairs of adjacent disks rotate in the same direction and some rotate in opposite directions depending upon the intended location of the feed position of the cut crop as they pass over the disks for collection.

The shape and arrangement of the disk itself is not shown in detail since this is well known to one skilled in the art and different arrangements of disk can be used including various components on the disk for guiding the crop.

Depending upon the direction of rotation of the disk, each blade defines a leading edge 30 and a trailing edge 31. The leading edge is sharpened to provide a cutting action. The trailing edge is generally not sharpened although it may be sharpened if it is intended that the blades be rotated when worn at the leading edge. Each blade has an inner end 32 mounted on the mounting pin 27A. Each blade has an outer edge 33.

Turning now to FIGS. 3, 4 and 5, there is shown in more detail the blade 27 including the leading edge 30, the trailing edge 31, the inner portion 32 and the outer edge 33. The blade is formed from a strip of metal so as to have basically parallel front and rear sides 34 and 35 with an inner edge 36 at right angles to the parallel front and rear sides. The leading edge 30 forms a part of the front edge 34 and is sharpened by a chamfered edge 37 which inclines downwardly and forwardly to a sharpened bottom edge 38 at the bottom surface of the blade with the sharpened edge terminating in the top surface of the blade at a line 39. Thus the leading edge defines an outermost point 40 and extends along the front edge 38 to an end 41 of the leading edge 30. A hole 42 for mounting the inner end portion 32 on the pin 27A is moved forwardly from the rear edge 35 toward the front edge 34. Thus the distance of a center 43 of the hole is closer to the front edge 34 than the rear edge 35. The generally rectangular blade has a center of mass 44 approximately at the center. It will be appreciated that, when the blade is mounted on the pin 27A with the pin defining a pivot axis at the center of the hole 42, centrifugal force on the blade caused by the rotation of the mounting disk on which it is attached causes the center of gravity 44 to extend in a radial line from the center of the disk. This radial line which is of course imaginary is indicated at 45. The line 45 is at an angle to the front edge 34 and to the rear edge 35. Thus the sharpened edge 38 in this embodiment is a straight line from the outer end 40 to the inner end 41. This straight line lies at an angle to the imaginary line 45 so that when the blade is rotating with the line 45 extending radially from the center of the disk, the end 40 is angularly advanced relative to the end 41 of the sharpened leading edge.

The outer edge 33 of the blade is cut back so that the length of the edge 34 is longer than the edge 35. This makes the outer end 40 of the sharpened leading edge the radially outermost point so that remainder of the edge 33 follows behind the outermost point 40 and does not itself engage the crop. In the embodiment shown the edge 33 is straight and at a right angle to the imaginary line 45.

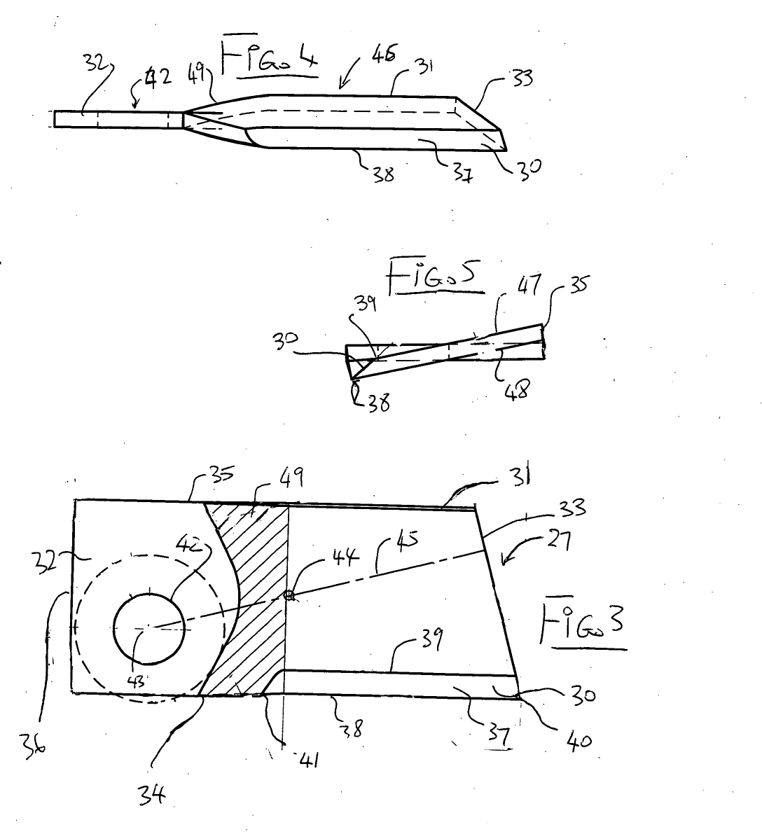

As shown in FIGS. 4 and 5 the blade is also twisted so that a cutting portion 46 defined by the leading edge and the trailing edge and the trailing edge 31 together with an upper surface 47 and a bottom surface 48 is twisted relative to the inner portion 32 in a twisting zone 49. Thus with the inner portion 32 lying in a radial plane of the axis of rotation of the disk, the cutting portion 46 is slightly twisted so that the trailing edge 35 is above the leading edge 30 and the surface 47 is inclined upwardly and rearwardly. This tends to engage and lift the crop.

The fact that the cutting edge of the blade is inclined forwardly relative to the radial line through the center of the disk and the blade pivot causes crop material engaging the blade to tend to move inwardly relative to the blade so that it is gathered by the blade. It will be appreciated that crop material engaging the blade in some cases can tend to pivot the blade slightly angularly around the pivot in a retarding action so that the conventional leading edge can be inclined in a slightly angularly retarded direction. In addition the centrifugal force generated by the rotation on the crop can tend to cause the crop to slip off the end of the blade into the area which has not yet been cut. The intention of the present invention is to tend to gather the crop so that it is pulled inwardly toward the disk away from the outermost end of the leading edge.

In addition the gathering of the crop toward the center of the disk causes more crop to flow over the disks rather than between the disks and thus the matter material delivered rearwardly of the disks is more consistent across the width of the crop.

Thus the tendency to draw the crop inwardly toward the center of the disc may reduce the tendency of the crop materials from each disc to be ejected by the rotation of the disc into the space between the two discs, which can cause concentration of the crop in these areas potentially interfering with the proper flow.

This is particularly important in relation to those disks where the rotation of the disks causes the blades to move apart in front of the cutting bar as shown in FIG. 2. It has been found that the cutting action in this area which is necessary at least between one pair of disks and generally more depending upon the number of disks on the cutter bar is particularly problematic due to the tendency of the blades to expel the crop material into the space between these disks. The tendency of the blades to pull the crop inwardly rather than expel it outwardly relative to the axis of the disk improves a cutting action in the zone between the disks.

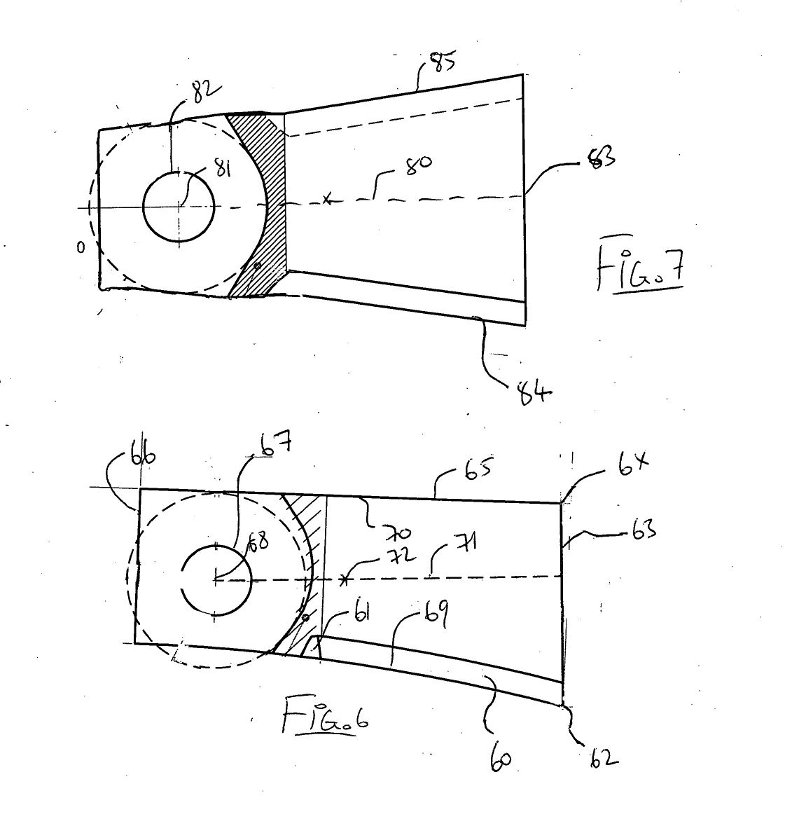

In FIG. 6 is shown an alternative arrangement in which the leading edge 60 is slightly curved. However the curvature is such that each point on the leading edge is angularly advanced relative to a next adjacent inner point. The leading edge 60 extends from the inner end 61 to the outer end 62 where the outer end forms a point and defines the outermost radial location on the blade. Again the side edge 63 is trimmed back so that it extends rearwardly and inwardly to a rear end 64 of the side edge which intersects with the trailing edge 65. In this arrangement the blade is not formed a strip of material so that its width at the outer edge 63 is greater than its width at the inner edge 66. The hole 67 has a center 68 which again is slightly closer to the front edge 69 of the blade then it is to the rear edge 70 of the blade. Again therefore an imaginary line 71 which extends from the center 68 outwardly through the center of mass 72 is arranged at an angle to the leading edge 60. The imaginary line 71 intersects the outer edge 63 at a right angle.

In FIG. 7 is shown a yet further modified arrangement in which the blade is symmetrical about an imaginary line 80 which extends from the center 81 of the hole 82 to the outer edge 83 of the blade. In this case both the leading edge 84 and the trailing edge 85 are arranged at an angle to the line 80 so that again each point along the leading edge 84 is angularly advanced relative to a point inwardly thereof.

In the embodiment of FIG. 7, however, the blade is symmetrical so that both the leading and trailing edges are sharpened and thus the blade can be used in either direction by inverting the blade.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A crop harvesting header comprising:
a cutter bar mounted across a width of the header for movement across the ground for harvesting a standing crop;
a plurality of generally horizontal cutter disks mounted on the cutter bar at positions spaced transversely of the header with the disks being mounted on the cutter bar for driven rotation about respective generally upright axes spaced along the cutter bar;
each disk having mounted thereon at a position spaced outwardly from the respective axis thereof at least one cutter blade such that rotation of the disk about its axis causes a standing crop to be cut by the blade as it rotates around the axis on the disk;
each of the blades of the cutter disks having a leading cutting edge arranged generally in a radial plane of the axis and extending generally outwardly from the axis from an inner end of the leading edge to an outer end of the leading edge;
each of the blades being shaped and arranged such that the outer end of the leading edge is angularly advanced relative to the inner end.

2. The header according to claim 1 wherein the blade is mounted for pivotal movement about a pivot axis inwardly of the inner end of the leading edge and generally parallel to the axis of the respective disk.

3. The header according to claim 2 wherein the blade is arranged such that the pivot axis is located such that a line joining the pivot axis and a center of gravity of the blade is at an angle to a line joining the inner end and outer end of the leading edge, such that, with the center of gravity located radially outwardly of the pivot axis due to centrifugal force, the outer end of the leading edge is angularly advanced relative to the inner end.

4. The header according to claim 1 wherein the blade is generally rectangular in plan to define the leading edge, a trailing edge, an inner edge and an outer edge and wherein the pivot axis is located at a position closer to the leading edge than the trailing edge.

5. The header according to claim 4 wherein the outer edge is inclined rearwardly and inwardly such that the outer end of the leading edge constitutes the radially outermost point on the outer edge.

6. The header according to claim 1 wherein the blade is shaped to define an outer edge which is inclined rearwardly and inwardly such that the outer end of the leading edge constitutes the radially outermost point on the outer edge.

7. The header according to claim 1 wherein the blade is shaped to define a trailing edge extending generally outwardly from the axis behind the leading edge and the blade is twisted such that the trailing edge is above the leading edge tending to lift the crop as the blade passes through the crop.

8. The header according to claim 1 wherein the leading edge lies on a straight line.

9. The header according to claim 1 wherein the leading edge is curved outwardly and forwardly and is shaped such that each point outward of another point on the leading edge is angularly advanced relative to said another point.

10. The header according to claim 1 wherein the blade is shaped to define a line of symmetry extending from the pivot axis along a radial line to an outer edge and a trailing edge extending generally outwardly from the axis behind the leading edge and behind the line of symmetry, and wherein each of the leading edge and the trailing edge are inclined relative to the line of symmetry such that the blade increases in width from the inner end of the leading edge to the outer end of the leading edge.

11. The header according to claim 10 wherein both the leading and trailing edges are sharpened to allow the blade to be mounted in reverse orientation.

12. The header according to claim 1 wherein each disk has two blades at diametrically opposite positions on the disk.

13. The header according to claim 12 wherein the disks are shaped such that the disk has a transverse dimension at the blades which is greater than at a position at ninety degree spacing from the blades.

14. The header according to claim 12 wherein the disks are arranged such that the blades of one are ninety degrees offset from the blades of the next.

15. A flail blade for mounting on a rotating member for cutting crop, the blade comprising a metal plate having
an opening therein defining a pivot mounting for a pivot axis at which the blade is mounted on the rotating member;
a leading cutting edge arranged generally in a radial plane of the axis and extending generally outwardly from the axis from an inner end of the leading edge to an outer end of the leading edge;
the blade being shaped and arranged such that, when mounted on the pivot mounting and rotated by the rotating member, the outer end of the leading edge is angularly advanced relative to the inner end.

16. The blade according to claim 15 wherein the pivot axis is located such that a line joining the pivot axis and a center of gravity of the blade is at an angle to a line joining the inner end and outer end of the leading edge, such that, with the center of gravity located radially outwardly of the pivot axis due to centrifugal force, the outer end of the leading edge is angularly advanced relative to the inner end.

17. The blade according to claim 15 which is generally rectangular in plan to define the leading edge, a trailing edge, an inner edge and an outer edge and wherein the pivot axis is located at a position closer to the leading edge than the trailing edge.

18. The blade according to claim 17 wherein the outer edge is inclined rearwardly and inwardly such that the outer end of the leading edge constitutes the radially outermost point on the outer edge.

19. The blade according to claim 15 wherein the blade is shaped to define an outer edge which is inclined rearwardly and inwardly such that the outer end of the leading edge constitutes the radially outermost point on the outer edge.

20. The blade according to claim 15 wherein the blade is shaped to define a trailing edge extending generally outwardly from the axis behind the leading edge and the blade is twisted such that the trailing edge is above the leading edge tending to lift the crop as the blade passes through the crop.

21. The blade according to claim 15 wherein the leading edge lies on a straight line.

22. The blade according to claim 15 wherein the leading edge is curved outwardly and forwardly and is shaped such that each point outward of another point on the leading edge is angularly advanced relative to said another point.

23. The blade according to claim 15 wherein the blade is shaped to define a line of symmetry extending from the pivot axis along a radial line to an outer edge and a trailing edge extending generally outwardly from the axis behind the leading edge and behind the line of symmetry, and wherein each of the leading edge and the trailing edge are inclined relative to the line of symmetry such that the blade increases in width from the inner end of the leading edge to the outer end of the leading edge.

24. The blade according to claim 23 wherein both the leading and trailing edges are sharpened to allow the blade to be mounted in reverse orientation.
